(19) United States
(12) Patent Application Publication
(10) Pub. No.: US 2017/0244909 A1
(43) Pub. Date: Aug. 24, 2017

(54) PORTABLE VIDEO STUDIO KITS, SYSTEMS, AND METHODS

(71) Applicant: Christopher Michael Dannen, Brooklyn, NY (US)

(72) Inventor: Christopher Michael Dannen, Brooklyn, NY (US)

(21) Appl. No.: 15/442,309

(22) Filed: Feb. 24, 2017

Related U.S. Application Data
(60) Provisional application No. 62/299,493, filed on Feb. 24, 2016.

(51) Int. Cl. H04N 5/28; H04N 5/225

(52) U.S. Cl. CPC H04N 5/28; H04N 5/2253; H04N 5/2252; H04N 5/2256

(57) ABSTRACT

According to one aspect, it is realized that automated video production systems can be provided that are fully integrated, and even portable, thus permitting use by a wide variety of consumers. Stated broadly, various embodiments are directed to systems, methods, and kits configured to provide complete video production, which in some examples enables a sole operator to set up and use the production system. Additional embodiments incorporate remote management applications that can configured to communicate with device application programming interfaces (APIs) installed on the video systems and/or kits. In one embodiment, remote personnel can remotely operate the video equipment, and interact with the video subject once the kit is setup and activated. In some examples, news station personnel can ship a video studio kit to an interview location, and once set up, news personnel may conduct an interview with any subject from a remote location.

### RELATED APPLICATIONS

This application claims priority under 35 U.S.C. §119(e) to U.S. Provisional Application Ser. No. 62/299,493 entitled “PORTABLE VIDEO STUDIO KITS, SYSTEMS, AND METHODS,” filed on Feb. 24, 2016, which application is incorporated herein by reference in its entirety.

### BACKGROUND

Current systems and methods for producing high-quality video production are prohibitively expensive, generally requiring specialized video and audio equipment. Typically the specialized video and audio equipment is bulky, fragile, and requires professional lighting to provide an optimal environment. Further, conventional video production (e.g., news casting) can be further limited by the need for highly trained personnel to operate or manage the video, audio, and lighting equipment. Because such systems are expensive to purchase and operate (and may require production crews or union personnel) high quality video production generally cannot be achieved by the majority of consumers.

### SUMMARY

According to one aspect, it is realized that automated video production systems can be provided that are fully integrated, and even portable, thus permitting use by a wide variety of consumers. Stated broadly, various embodiments are directed to systems, methods, and kits configured to provide complete video production, which in some examples enables a sole operator to set up and use the production system. Additional embodiments incorporate remote management applications that can be configured to communicate with application programming interfaces (APIs) installed on the video systems and/or kits. In one embodiment, remote personnel can remotely operate the video equipment, and interact with the video subject once the kit is setup and activated. In some examples, news station personnel can ship a video studio kit to an interview location, and once set up, news personnel may conduct an interview with any subject from a remote location. For example, news personnel may operate the video kit via a connected device executing control applications. Authentication protocols can be executed to ensure remote access is limited to authorized users.

According to another aspect, the video production systems are supported by a light weight portable enclosure that is configured to connect with a decentralized network. In some embodiments, the enclosure is configured for multi-mode operations including a broadcast mode for broadcasting on the network and a receiving mode for receiving content from the network. Other modes include a two-way mode for enabling remote control of the enclosure and attached peripherals. The two-way mode facilitates interview style video capture which can also be broadcast on the decentralized network. The decentralized video network represents a marked departure from conventional network television function and underlying architecture. Transactional services executing on the enclosure are configured to support the network, providing for decentralized execution of smart contracts that enable charges for receiving content and payments for broadcasting content.

According to one embodiment, the video studio kit is an on-demand, light-weight, portable, and pre-set up camera, sound and lighting rig. Other embodiments provide an integrated housing, attachment ports, and attachment structures on the housing for elements of the video kit. Various examples integrate one or more cameras, one or more LED lights, at least one microphone, and a frame for mounting each component. Further examples, provide attachment structures on a housing so that an end user can supply and/or integrate their own devices on the fly. In some embodiments, the video studio kit is constructed so that each of the components is readily mounted to a collapsible frame that is portable and fits inside a typical suitcase. For example, a hard side suitcase can be delivered (e.g., via bike messenger) to any location, and the suitcase includes the components and frame. Once the user opens the suitcase, unpacks the kit, and turns the system on, high quality video studio production is made available. In further examples, integrated power eliminates cabling issues, solves location based power limitations, and further reduces setup time and complexity. Other approaches include delivering an enclosure (e.g., roughly hand sized) that enables the end user to connect their existing peripherals (e.g., camera, lights, microphone, tripod, etc.) to enable high quality video studio production and, for example, multi-mode operations (e.g., receive, broadcast, two-way, etc.).

In still other examples, the systems and/or kits include integrated communication systems. The integrated communication systems are configured to discover available components and manage the various elements to operate as a cohesive production studio. The integrated communication components can also be used for remote based control of the video kit. For example, television personnel can mail a studio kit to an interview subject, and still control the video capture and manage video interactions of an interview subject. In some embodiments, the various components of the studio kit are pre-configured with authentication information. The television personnel can remotely control the kit via management applications once properly authenticated.

According to one aspect, a video production kit is provided. The kit comprises an enclosure including a processing component, a communication component, a battery, a first light attachment structure in the enclosure, a first housing attached to the enclosure and constructed to mate with a first camera, and wherein the processing component is configured to control the first camera and the first light responsive to control commands received via the communication component. According to one embodiment, the processing component is programmed to automatically recognize peripheral devices for use with the video kit. In one example, the peripheral devices are identified responsive to connection to the available ports. In another example, wireless discovery can identify peripheral devices for integration into the kit.

According to one aspect, a video production kit is provided. The kit comprises an enclosure including a processing component, a communication component, a battery, a first light attached to the enclosure, a first camera, a first housing attached to the enclosure and constructed to mate with the first camera, and wherein the processing component is configured to control the first camera and the first light responsive to control commands received via the communication component.

According to one embodiment, the kit further comprises at least a second light attached to the enclosure, wherein the second light is attached with an articulating connection. According to one embodiment, the kit further comprises at least a third light attached to the enclosure, wherein the first and third light are configured to illuminate a foreground within captured video. According to one embodiment, the kit further comprises a second housing attached to the enclosure constructed to mate with a second camera. According to one embodiment, the kit further comprises a tripod having a releasable attachment portion to connect to the enclosure.

According to one aspect, a video production system is provided. The system comprises at least one processor operatively connected to a memory constructed and arranged within a portable enclosure, a discovery component, executed by the at least one processor, configured to identify and install a plurality of video production devices, wherein the plurality of video production devices include at least a first camera, a first light, and a first microphone, a video capture component, executed by the at least one processor, configured to control operating parameters of at least the first camera, the first light, and the first microphone, a communication component configured to accept remote commands from at least one user, and communicate the remote commands to the video capture component to control the operating parameters of the first camera, the first light, and the first microphone (or any video production device), and the portable enclosure housing the at least one processor and at least one battery, wherein the portable enclosure is constructed and arranged with a plurality of mounting positions for at least respective ones of the plurality of video production devices.

In some embodiments, each device in the video production system is configured to accept discovery of the other components of the video production system (e.g., lights, camera, microphone, etc.) either upon connection to communication ports or based on wireless discovery (e.g., proximity communication). A master security component can be configured to manage secure IDs and connections between the various components. Once identified and authorized the security component can be configured to pass control of the various components to remote applications. The remote applications can be configured for local operation on a nearby device (e.g., mobile phone) or for operation from remote locations.

According to one aspect, a computer implemented method for video production is provided. The method comprises receiving a video production system, unpackaging and activating the video production system with a minimal number of user actions (e.g. one or more assembly actions (e.g. connect tripod to enclosure and a power on action), two or more assembly actions (e.g. connect tripod, position or connect a housing component, position or connect a camera or light or microphone to/on an enclosure), controlling a plurality of devices of the video production system via commands input into a remote interface, triggering video capture by the video production system, and manipulating operational characteristics of the plurality of devices during video capture via input into the remote interface.

According to one aspect, a method for on demand video production is provided. The method comprises receiving a request via an online interface for a video production system, shipping the video production system to a specified location and for a time period specified in the request, generating remote access information for operating the video production system, and triggering a return request automatically responsive to a conclusion of the time period specified, such that the video production system communicates the return request and effectuates the return of the video production system to a return location.

According to one aspect, a video production kit is provided. The kit comprises an enclosure, wherein the enclosure further includes: a processing component having at least one processor operatively connected to a memory; a communication component; a battery; a first port for receiving a physical connector to a first light; a second port for receiving a physical connector to a first camera; a first mount within the enclosure constructed to mate with the first camera; a second mount within the enclosure constructed to mate with a tripod; and wherein the processing component is configured to control the first camera and the first light responsive to control commands received via the communication component.

According to one embodiment, the kit further comprises a first light connectable to the enclosure through a physical connector or through the communication component and a first camera connectable to the enclosure through a physical connector or through the communication component. According to one embodiment, the kit further comprises at least a second light connectable to the enclosure through a physical connector or through the communication component, wherein the first and the at least the second light are positioned to illuminate a foreground and background within captured video.

According to one embodiment, the kit further comprises a discovery component, executed by the at least one processor, configured to identify and install a plurality of video production devices, wherein the plurality of video production devices include at least one of: a first camera, a first light, a first microphone, and a first headset which can include the first microphone. According to one embodiment, the kit further comprises a second housing attached to the enclosure constructed to mate with a second camera. According to one embodiment, the kit further comprises a tripod having a releasable attachment portion to connect to the enclosure.

According to one embodiment, the at least one processor is further configured to manage transitions between a plurality of operating modes responsive to requests in a user interface. According to one embodiment, the plurality of operating modes includes at least one of: broadcast mode, a receive mode, and a two-way mode. According to one embodiment, the at least one processor is further configured to: execute a transition to a two-way mode responsive to input in a user interface; test connected video production devices to determine a proper state for functionality within the two-way mode; and permit full functionality in the two-way mode responsive to a successful test.

According to one embodiment, the at least one processor is configured to: deny a transition to two-way mode responsive to a failed test; and enter a reduced functionality two-way mode or prevent transition to the two-way mode; and communicate to the user interface information on a failure condition. According to one embodiment, the at least one processor is further configured to establish a broadcast to a second video production kit and received a broadcast from the second video production kit when in the two-way mode. According to one embodiment, the at least one processor is further configured to accept and execute control commands on the plurality of video production devices from the second video production kit when in the two-way mode.

According to one embodiment, the at least one processor is configured to: execute a transition to a broadcast mode responsive to input in a user interface; capture video from a first camera and audio from a first microphone; communicate a data stream including the video and the audio to a content server; and receive and authorization signal from the content server to broadcast. According to one embodiment, the at least one processor is configured to: execute a transition to a receive mode responsive to input in a user interface; receive a data stream including video and audio generated at another video production kit; display in a user interface the video and audio; and limit functionality in the receive mode to display of the data stream and exiting the received mode.

According to one aspect, a video production system is provided. The system comprises at least one processor operatively connected to a memory constructed and arranged within a portable enclosure; a discovery component, executed by the at least one processor, configured to identify and install a plurality of video production devices, wherein the plurality of video production devices include at least a first camera, a first light, a first microphone, and a first headset which can include the first microphone, wherein the plurality of video production devices are connectable to the portable enclosure via a physical connector or wirelessly; a video capture component, executed by the at least one processor, configured to control operating parameters of at least the first camera, the first light, and the first microphone; a communication component configured to accept remote commands from at least one user, and communicate the remote commands to the video capture component to control the operating parameters of the first camera, the first light, and the first microphone; and the portable enclosure housing the at least one processor and at least one battery, wherein the portable enclosure is constructed and arranged with a plurality of communication ports for at least respective ones of the plurality of video production devices, and a first mount for the first camera and a second mount for a tripod.

According to one embodiment, the at least one processor is further configured to manage transitions between a plurality of operating modes responsive to requests in a user interface. According to one embodiment, the plurality of operating modes includes at least one of: broadcast mode, a receive mode, and a two-way mode. According to one embodiment, the at least one processor is further configured to: execute a transition to a two-way mode responsive to input in a user interface; test connected video production devices to determine a proper state for functionality within the two-way mode; and permit full functionality in the two-way mode responsive to a successful test.

According to one embodiment, the at least one processor is configured to: deny a transition to two-way mode responsive to a failed test; enter a reduced functionality two-way mode or prevent transition to the two-way mode; and communicate to the user interface information on a failure condition. According to one embodiment, the at least one processor is further configured to establish a broadcast to a second video production system and received a broadcast from the second video production system when in the two-way mode. According to one embodiment, the at least one processor is further configured to accept and execute control commands on the plurality of video production devices from the second video production system when in the two-way mode.

According to one embodiment, the at least one processor is configured to: execute a transition to a broadcast mode responsive to input in a user interface; capture video from a first camera and audio from a first microphone; communicate a data stream including the video and the audio to a content server; and receive and authorization signal from the content server to broadcast. According to one embodiment, the at least one processor is configured to: execute a transition to a receive mode responsive to input in a user interface; receive a data stream including video and audio generated at another video production system; display in a user interface the video and audio; and limit functionality in the receive mode to display of the data stream and exiting the received mode.

According to one aspect, a computer implemented method for video production is provided. The method comprises discovering, by at least one processor, a plurality of video production devices for use in a video production kit; controlling, by at least one processor, the plurality of video production devices via commands input into a remote interface; managing, by at least one processor, transitions between a plurality of operating modes for the video production kit; triggering video capture by the video production system; and manipulating operational characteristics of the plurality of devices during video capture via input into the remote interface.

According to one embodiment, the plurality of operating modes includes at least one of: broadcast mode, a receive mode, and a two-way mode. According to one embodiment, the method further comprises executing, by the at least one processor, a transition to a two-way mode responsive to input in a user interface; testing, by the at least one processor, connected video production devices to determine a proper state for functionality within the two-way mode; and permitting, by the at least one processor, full functionality in the two-way mode responsive to a successful test.

According to one embodiment, the method further comprises denying, by the at least one processor, a transition to two-way mode responsive to a failed test; entering, by the at least one processor, a reduced functionality two-way mode or prevent transition to the two-way mode; and communicating, by the at least one processor, to the user interface information on a failure condition. According to one embodiment, the method further comprises establishing, by the at least one processor, a broadcast to a second video production system and receiving, by the at least one processor, a broadcast from the second video production system when in the two-way mode.

According to one embodiment, the method further comprises accepting, by the at least one processor, and executing, by the at least one processor, control commands on the plurality of video production devices from the second video production system when in the two-way mode. According to one embodiment, the method further comprises executing, by the at least one processor, a transition to a broadcast mode responsive to input in a user interface; capturing, by the at least one processor, video from a first camera and audio from a first microphone; communicating, by the at least one processor, a data stream including the video and the audio to a content server; and receiving, by the at least one processor, and authorization signal from the content server to broadcast.

According to one embodiment, the method further comprises executing, by the at least one processor, a transition to a receive mode responsive to input in a user interface; receiving, by the at least one processor, a data stream including video and audio generated at another video production system; displaying, by the at least one processor, in a user interface the video and audio; and limiting, by the at least one processor, functionality in the receive mode to display of the data stream and exiting the received mode.

Still other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1A illustrates an embodiment of an enclosure for a video studio kit;

FIG. 1B illustrates an embodiment of an enclosure for a video studio kit;

FIG. 2 is a schematic diagram of an embodiment of an enclosure for a video studio kit;

FIG. 3 is an example wiring diagram for an embodiment of a video studio kit;

FIG. 4 is a block diagram of a video production system, according to one embodiment;

FIG. 5 is an example process for video captures, according to one embodiment;

FIG. 6 is an example process for automatic return of the video system, according to one embodiment;

FIGS. 7-9 illustrate example user interfaces, according to some embodiments;

FIG. 10 is an example process flow for executing two-way mode, according to some embodiments;

FIG. 11 is an example embodiment of a video studio kit and enclosure; and

FIG. 12 is an example diagram of a distributed computer system which may be used to implement some embodiments.

### DETAILED DESCRIPTION

According to one aspect, various kits, systems, and methods provide for an automated video reporting device configured, for example, to replace a human videographer/reporter who goes out into the field to collect an interview from a human subject. According to one embodiment, the systems and/or kits can include an aluminum computer integrated enclosure with multiple lights (e.g., at least two front lights and at least one background light). In one example, three LED lights are attached to the aluminum enclosure and are configured for foreground and background lighting. In some examples, the integrated computer enclosure does not need a display screen, and control over the lights and videography is managed via an application or web based API. For example, the brightness/hue of the two key lights (and/or the background light) can be controlled via the web or application interface.

According to another embodiment, a smaller enclosure can be used having a camera mount, tripod mount, and ports for connecting peripherals. The enclosure includes an integrated computer system (e.g., printed circuit board, network card (e.g., cellular or wireless), etc.) specially configured to operate in a decentralized video broadcast network. The integrated computer system is configured to manage the device in multiple modes of operation. Further, the computer system manages peripheral discovery, and for example in the two-way mode, remote based control of the enclosure and all connected peripherals of a local enclosure by a remote based enclosure/system. The small form factor, coupled with ease of execution make the video production service a significant departure from conventional video production and operation. In one example, the enclosure/device is approximately the size of the softball, and in others can be a rectangular structure 18-24 inches long.

For example, various conventional implementations of video broadcast (e.g., via radio transmission or internet), can be characterized as a one-to-many relationship between broadcaster and audience. The hardware used for conventional broadcasting is bifurcated to reflect this relationship: TVs are for consumption and PCs are for editing/creation/publishing. According to one aspect, the video studio kit and various embodiments of the associated video capture device are built on a many-to-many video broadcast network. The various devices operate together to establish a many-to-many broadcast network.

According to one embodiment, in the network, the normal functions of a conventional TV network are handled instead semi-autonomously by a decentralized peer to peer network. In some examples, the architecture of the devices and network offers significant improvement over the conventional model and approach. For example, the approach eliminates central administration and points of failure. Further, new devices can be added to the network easily and seamlessly—in both broadcast and receive modes. Moreover each device can transition between modes responsive to settings on the system. For example, the individual devices are configured for multi-mode execution (discussed in greater detail below), where users can watch video through the network or broadcast content to the network for viewing.

In further embodiments, the aluminum enclosure can rest on an integrated tripod mount. The respective components, lights, tripod, etc., can be attached to the enclosure with removable or collapsible connections, which are configured to fold quickly or detach from the enclosure to enable the kit to fit into its own suitcase. Various embodiments integrate IPHONE mobile devices and cameras, however, other mobile devices can be mounted to the enclosure. In some examples, housing elements for two or more mobile devices are attached to the enclosure.

In some embodiments, the enclosure includes mating positions for a camera and tripod, and has available ports to connect peripheral devices (e.g., lights, microphone, etc.). Within the enclosure is a computing element configured with wireless communication (e.g., via a wireless network interface card and/or cellular interface circuit) that can connect and integrate peripheral devices. In other examples, housing elements can be connect to the mating positions or the device itself can mate directly at the mating positions.

Various mobile devices can be mated with the housing elements and positioned so that the best camera available on the device (e.g., typically a rear facing camera on a mobile device) is directed towards a video subject. As illustrated in greater detail below, some examples include IPHONES mated to the enclosure, however, other embodiments use other mobile devices (e.g., ANDROID based devices, SAMSUNG mobile devices, etc.). In further embodiments, any kind of camera(s) or telepresence screen can be mounted to the enclosure with respective housing elements (e.g., DSLR cameras, etc.) and can be mounted between any lights. In various embodiments, the enclosure includes many mount holes and mounting architectures to accommodate various cameras, phones, microphones, and/or tablets.

Various embodiment may include an enclosure the measures about 21 inches long by 2 inches high by 6 inches deep (21×2×6). Other embodiments provide a smaller form factor measuring about 6 inches by 6 inches (i.e., softball sized). Regardless of the dimension each device is assigned one or more one or more Ethereum addresses (sometimes called a wallet address or “public key”) used to send, hold, receive ether and each device node can be configured with a canonical token address, which is used to identify it within our network (e.g., when two peers connect).

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

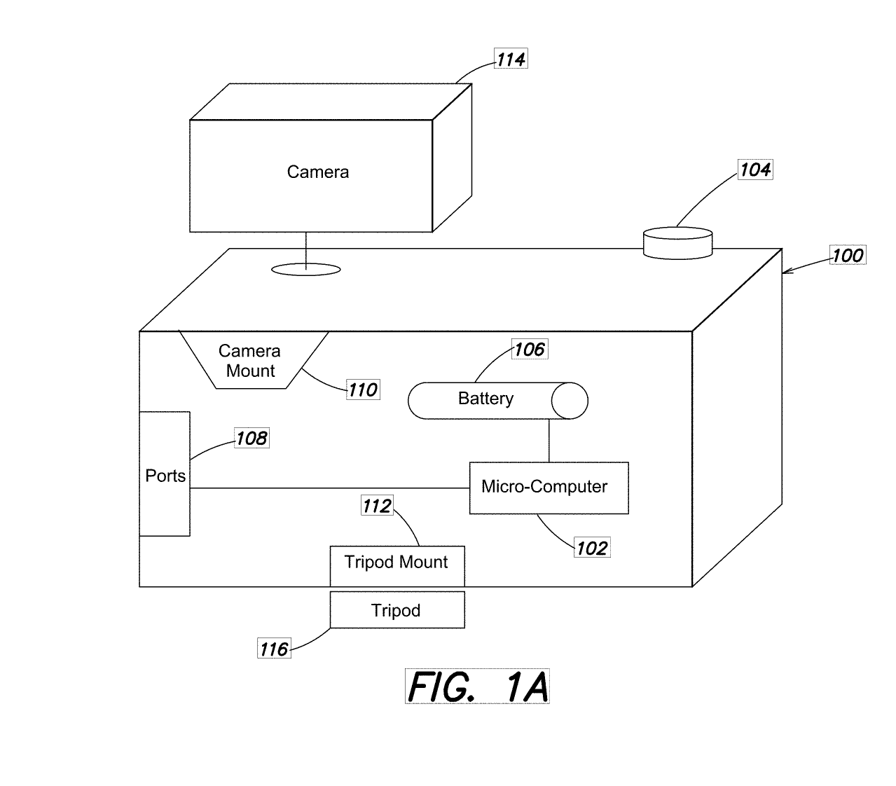

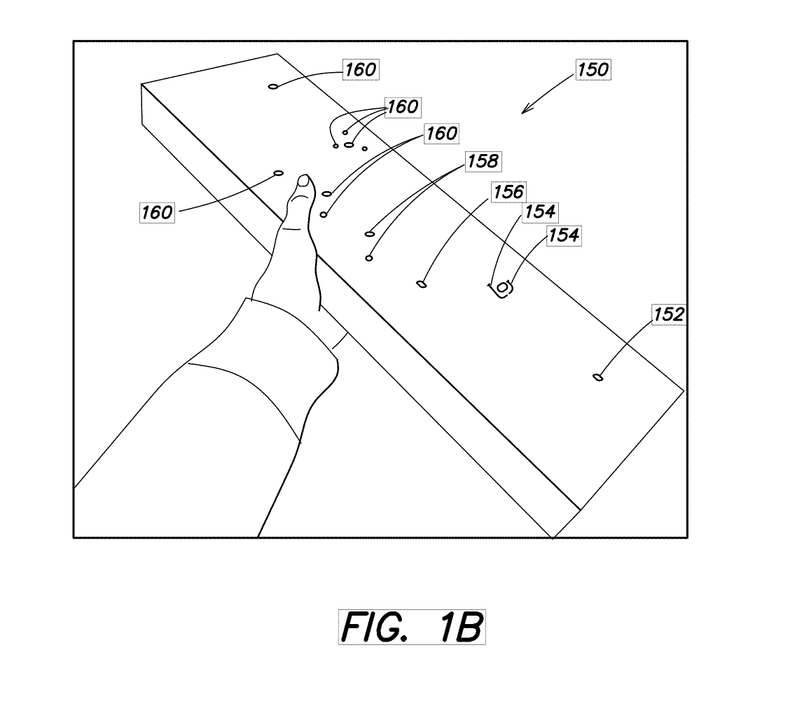

Shown in FIG. 1A is an embodiment, of a computer integrated enclosure 100 which is constructed as a self-contained computer enclosure. The enclosure 100 can include onboard batteries 106, integrated wireless connectivity (not shown)(e.g., wireless NIC, and/or 3G, 4G, LTE, etc.), and processing (e.g., a microcomputer 102 (which may be for example, a Raspberry Pi Zero or a custom processing component). The enclosure is constructed with ports at 108 to provide hardwire connectivity to peripheral devices. In further embodiments, the enclosure is configured to wirelessly discover peripherals (e.g., lights, microphones, etc.) and manage integration of the peripherals to provide control through operations of the enclosure 100.

According to one embodiment, the enclosure is constructed and arranged with a camera mount at 110 and a tripod mount at 112. A power button 104 provides control of the device's powered state. The camera mount at 110 can be a threaded opening for receiving a camera mounting screw. And a camera 114 can be attached to the mount 110 via the mounting screw. In other embodiments, a housing can be connected by a mounting screw and a mobile phone can be mated with the housing. Tripods (e.g., 116) can support the enclosure and any attached device by connection with the mount 112.

Shown in FIG. 1B is an embodiment, of a computer integrated enclosure 150 which is constructed as a self-contained computer enclosure. The enclosure can include onboard batteries, integrated wireless connectivity (e.g., 3G, 4G, LTE, etc.), and processing (e.g., a Raspberry Pi Zero can provide processing capacity). At 152-160, the enclosure can be constructed and arranged with a plurality of mounting holes. The holes can be used to mount peripheral devices directly to the enclosure, and in some embodiments can be configured to mate with housing structures adapted to secure various video studio components (e.g., lights, camera, mobile phone, microphones, etc.).

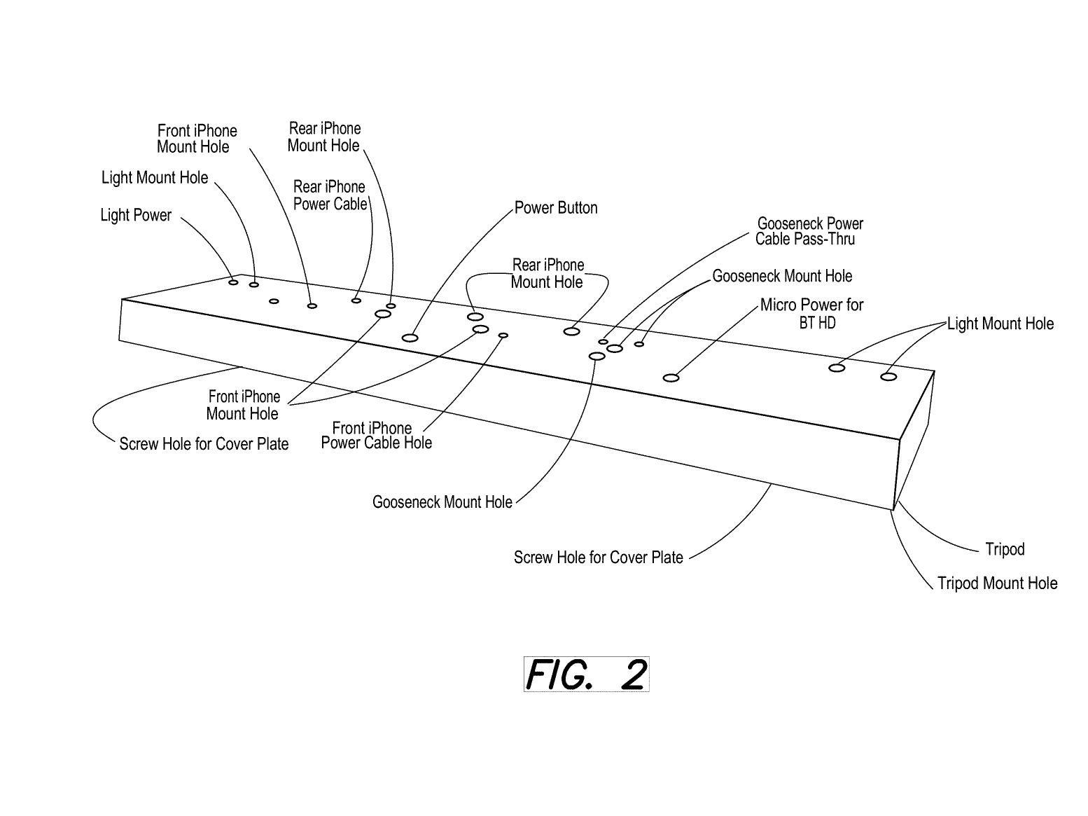

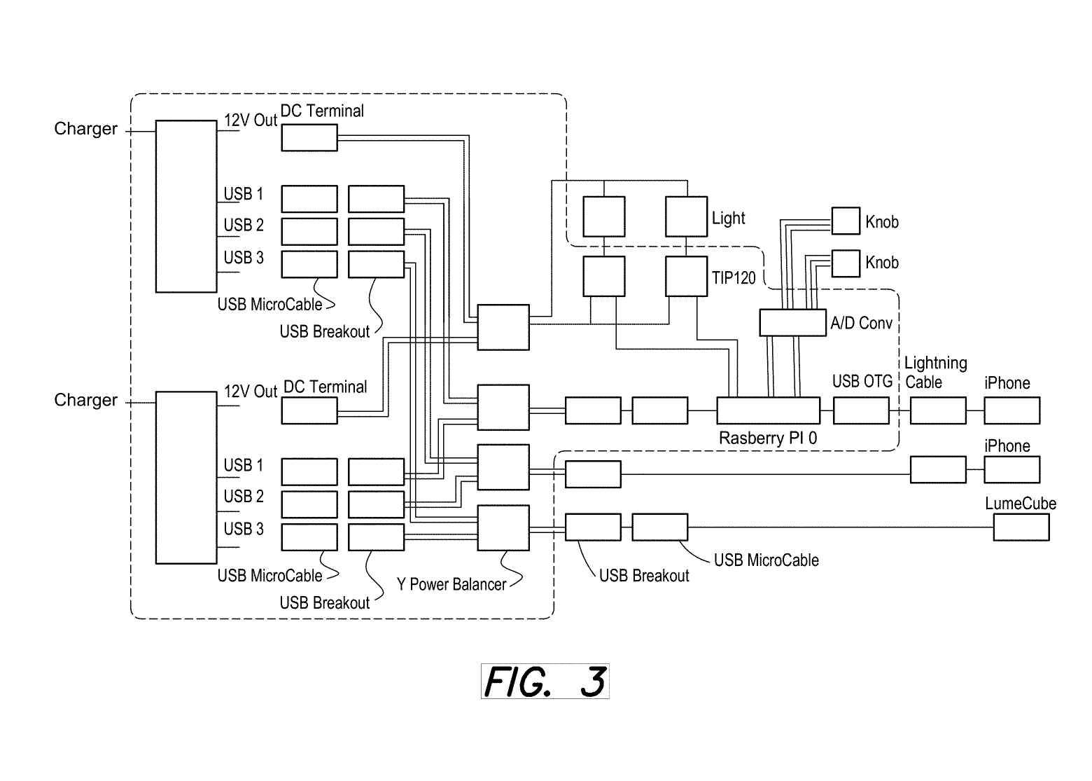

FIG. 2 is a schematic diagram of an embodiment of the enclosure and template for mounting the components of the video kit and/or system. FIG. 3 is an example circuit diagram for the video kit. According to one embodiment, some of the like components having similar positions in the circuit diagram have not been labelled. In further implementation, the circuit diagram can include one or more switches before the PI Zero component (not shown). In yet other examples, a resistor (e.g., 1M ohm resistor) can be included between the left and right leg of the TIP120 to ensure the TIP120 is off when the PI Zero is off.

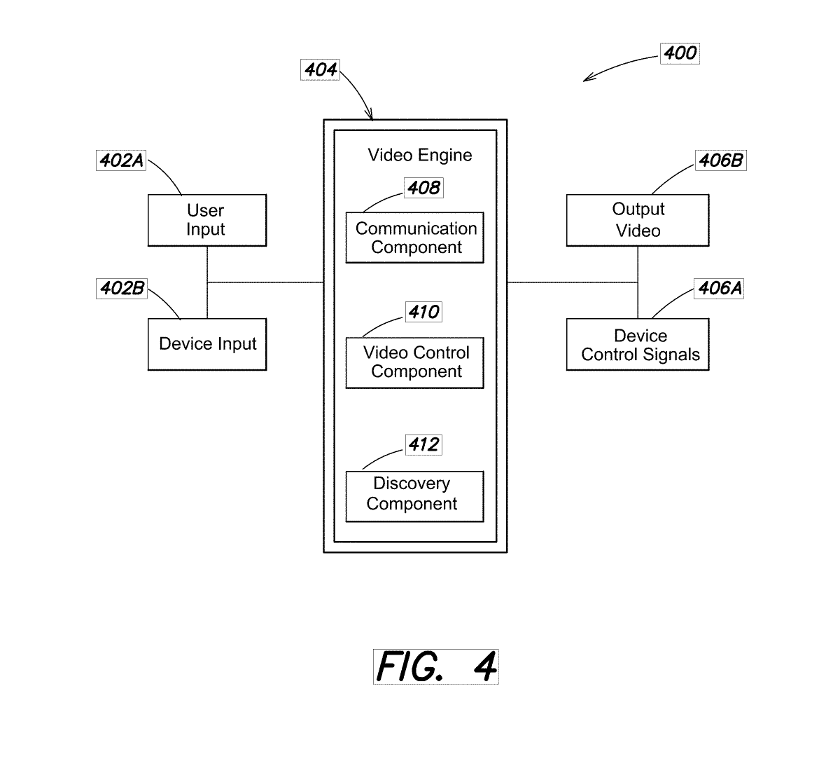

FIG. 4 is a block diagram of a video production system 400. The video production system can include a video processing engine 404 configured to receive user input 402A (e.g., remote input, for example, received from an API) and deliver device control signals 406A to connected devices (e.g., camera, lights, microphone, etc.). In some embodiments, the video processing engine 404 is configured to discover video production devices (e.g. at least a first and/or second camera, at least a first microphone, a plurality of lights (e.g., one, two and/or two foreground and one background)). In one example, via remote application or remote signal (e.g., from a user's mobile device), the video engine 404 enables a user to control any of the discovered video production devices.

For example, the user can begin recording high definition video, and audio with a click in a user interface display on their mobile device. In another example, a newscaster or production personnel can activate and control video and/or audio capture of a subject that was mailed a video production kit. The video feed and any audio can be streamed by the system 400 to a remote storage location (e.g., cloud based storage, or network storage), and can be monitored in real time (e.g., via an application on a mobile device). Real time monitoring enables real time lighting adjustments, for example, to improve the production value of the video capture, zooming within a field of view captured by the camera, cropping, sampling, etc. In further embodiments, the captured video can be processed by the video engine, effects added, and can include editing execution as part of the video capture process.

According to another embodiment, how content is processed, communicated, and/or stored depends on a mode of operation of the device controlled by the video control component 410. System inputs can transition the system between modes of operation. To provide an example of some operations, an end user would purchase or rent a device (e.g., the enclosure) and peripherals to watch or broadcast video. The end user can also purchase or enable more than one device and use them in concert. For example, upon broadcasting video content to the distributed network the end user can be compensated if the content is desirable to the other users of the network. Multiple systems can facilitate production of video content and broadcasting to the network.

In a two-way mode of operation, devices (e.g., enclosure 100, 150, or kit 1000) could be shipped into the field to do reporting outside the office, home, or studio. The two-way mode of operation of the device/kit simplifies the process of configuring a production studio to that of having an end user open a case and turn the device on. In the two-way mode, a paired device is configured to control the operation of shipped device remotely. Any connected peripherals can be controlled at the remote device and location. This mode can be used to conduct high quality video interviews.

In some embodiments, the system 400 and/or video engine 404 can include specialized components configured to perform device discovery and integration. In one embodiment, the system 400 and/or engine 404 can include a discovery component 412 configure to identify and communicate with video production devices. For example, the discovery component 412 can be configured to identify and connect mobile devices and associated cameras, lights, microphones, etc. The discovery component 412 can be configured to trigger discovery of wireless devices as well as wired devices, for example as they are plugged in or connected to the enclosure. The system can discover and integrate, for example, one or more microphones, one or more foreground lights, one or more background lights, a first camera (e.g., mobile device with a camera), a second camera (e.g., a second mobile device with a camera).

Once discovered and integrated a video control component 410 can be configured to manage settings on the respective device. For example, the video control component 410 can be configured to control the hue and brightness of the lights on the system and/or kit. In further examples, user input 402A can be delivered from anyplace using a device and a web browser connected to the system 400. Responsive to user input 402A the video control component 410 can be configured to output device control signals 406A to, for example, control hue and brightness of one or more foreground lights, and one or more background lights. In some embodiments, the video control component 410 can also be configured to provide video capture/editing/effects during a production session. For example, the video control component 410 can process device input 402B to identify facial characteristics and focus video capture on regions where a subject's face is present and output video 406B. The video control component 410 can process an input video feed from device input 402B to create a process video output 406B. In some embodiments, the output video 406B can be streamed to a cloud based storage location and/or streamed to a remotely connected device via communication component 408. In other embodiments, the output can be streamed to the user in real-time, and can provide input to enabling fine tune control (e.g., control lights, zoom, camera operation, etc.) of the video production on any remote device connected to the system 400.

According to one embodiment, the video production system can be part of a video studio kit. For example the kit can include lights, camera mount points (e.g., on the enclosure), one or more microphones, battery power (e.g., up to five hours of battery power for video production), and a tripod mount. The entire kit and, for example, the tripod mount is configured to fold neatly into a standard-sized suitcase. This video studio kit can be used for video chatting, making solo recording videos, or recording a two-way video conversation, all in HD.

According to one embodiment, the enclosure forms a remotely-operable computerized lighting platform for videography. The aluminum enclosure (e.g., 21″ long—sized to fit in a standard suitcase) houses a small computer processing element (e.g., a Raspberry Pi Zero) running video software and a web server for remote interaction. In one embodiment, the enclosure includes batteries, power controllers, a communication component 408 (e.g., a 3G modem, 4G, 4GLTE, etc.), one or more speakers, iBeacon device, and at least one physical antenna. Mounted on the outside of the enclosure are three portrait-sized photography floodlights powered by LEDs. Other embodiments of the enclosure are more compact. In one example, the portable enclosure (including processor, memory, battery, etc.) is roughly hand sized.

In some implementations, video control component 410 can include a video capture application (e.g., IOS video capture application and/or ANDROID control application, etc.) for users who attached a mobile device (e.g., an IPHONE 6S (which shoots 4K HD video)) to the device. Accordingly, the user can control the video capture camera remotely via their own mobile device. Combined with the remote controlling of the lights, various embodiments of the system and/or kit enable a director, editor, or producer to take highly-adjustable, great looking field video without sending a person into the field.

In further embodiments, the video production system (e.g., system 400, engine 404, and/or video control component 410) includes application and APIs to interface with video chat functions on any attached mobile device/camera. In one example, the software reacts to a beacon (e.g., IBEACON device in the enclosure) to allow discovery of the camera, integration with the camera's functionality and remote control of the camera. Thus, the remote connection enables the user to have full control of both the lighting and the camera settings, as if they were there in the room during, for example a video chat, video conference, etc. Some embodiment are configured for execution of this functionality in a two-way mode of operation where first device or video studio kit can communication and control a second video studio kit. In some examples, the mode can be truly two-way and each device may control functions on the respective remote system.

In some embodiments, the enclosure architecture includes mount holes for multiple mobile devices (e.g., two IPHONES mounted back to back) which enables video chatting on one device while shooting video with another. According to one embodiment, multiple video studio kits are configured to communication with each other to establish a network of video broadcast and/or chat points. The network of video broadcast and/or chat points can be likened to a network of phone booths. Where any participant can dial in to video chat with another. In some examples, video chatting can span multiple participants across multiple locations, and can also include a manager, controller, and/or editor who can capture video from any number of kits, and/or switch between video being captured at any number of kits. In some examples, APIs on the system and/or kit are configured to connect with existing or known video chat services (e.g., GOOGLE HANGOUTS, APPLE FACETIME, SKYPE, and WEBEX, etc.).

In one embodiment, video calls and remote controlling of rigs are coordinated through “transaction IDs.” Transactions IDs are unique codes that can be generated when the user establishes an interview appointment and/or delivery of video studio kit. The transaction IDs enable connections similar to a conference call to a conference call, establishing a temporary video chat and/or recording network between two or more video studio kits or systems, in which participating users can control their own and one another's cameras and lighting settings to optimize the experience and/or the recorded video.

According to another aspect, the device (e.g., 100, 105, 1000, and/or 400) runs a custom distribution of an off the shelf operating system (e.g., GNU Linux). The interface is configured to provide basic functionality and consume little in the way of processing power or memory. Executing in conjunction with the operating system platform is a cryptocurrency hardware wallet. The hardware is configured to execute an embedded “node” that is part of a blockchain, network (e.g., the ETHEREUM network). The hardware wallet can hold, send, and receive cryptocurrency payments denominated in ether. Similar to an System node, the hardware wallet can be used to create and interact with smart contracts on the System network. According to one embodiment, in addition to running an System node, the device also executes video capture and playback software. In some examples, the video capture and playback can be used in conjunction with a television via HDMI cable (e.g., via ports (108 of FIG. 1). The ports can also be used to connect the device to a desktop or other computing system.

As discussed above, the devices are configured to operate a distributed and decentralized network of nodes. Each of the devices is configured to operate with a computationally minimal set of protocols (e.g., similar to HTTP) to connect to the network and allow the devices to access content on other system, and/or the web. According to one embodiment, the nodes/devices operate in a fully decentralized transaction based network. For example, individual machines are not specifically addressable or identifiable in the transaction network per se, but instead are used to issue transactions or send data objects which trigger the issuing of transactions, in the distributed blockchain database/network. In various embodiments, all transactional/smart contract data for the network is stored redundantly on each node of the network. The architecture is configured for peer to peer operation, for example, like BitTorrent.

Operating Modes

According to various embodiments, the video engine 404 and/or the video control component is configured to manage functionality that executes in respective modes of operation of the device. For example, the video engine can manage transition between a broadcast mode, a receiver mode, a two-way mode, and an idle mode.

According to one embodiment, the broadcast mode is configured to operate irrespective of the hardware wallet network, in other works, the video broadcast functionality does not need to interact with the functionality provided in the distributed transaction network. In some embodiments, crediting of a hardware wallet may take place responsive to popular broadcasts or content. In one example, the video functionality is based on a SAAS/LAMP stack and provides video capture and broadcast functions. According to one embodiment, in the capture/broadcast mode, video is broadcast live from the device to content servers (e.g., cloud hosted or dedicated hardware servers) and then mirrored out through a content delivery network (CDN). The device can transmit identification information to the content servers to validate identity and authorization to broadcast (e.g., time slots may be allocated to specific device(s) based on, for example, popularity of content). In one example, the content servers and CDN operate much like a self-hosted video blog when actively broadcasting video. The stream of video is not stored on the content server but rather is stored on the local user device.

In some embodiments, the content servers are configured to manage timeslots for broadcast that are meted out via a web application interface. The end users devices are not typically configured for the broadcast management functions, however, in some embodiment, the devices can participate in managing the broadcast scheduling.

According to another embodiment, the video studio kits and/or video devices are further configured to operate in a receiver/display mode. The receiver modes is configured to play other user-generated video from the network. In some implementations, the operation of the receiver/display mode can requires two or more nodes to be connected to the network (e.g., one node to request and another node to delivery content), and each must be connected to the transactional network. Each device can be configured to stream respective video over a wifi connection or on-board cellular connection. In receiver/display mode, the video engine is configured to limit user interface options and user accessible functionality. In one example, there are no options provided in the user interface beyond an option to exit the receiver mode. When in this mode the device operates much like a cable television that plays only one channel. According to one embodiment, the device's available functionality is likewise limited to the operations needed to play the content currently being streamed to the device. Background functional associated with the transactional network can still take place, but other functionality (e.g., peripheral discovery) can be disabled until exiting the receiver mode.

In further embodiments, the mode is configurable between two settings: on and off. For example, upon activating receiver mode, the available content will auto-play on the device.

According to another embodiment, the device can be configured to provide a display mode. In some examples, the video engine can be configured to manage the available functionality accessible in the two-way mode. The two-way mode can be configured to take advantage of pairs of devices/kits. In some embodiments, the device and/or video engine is configured to validate the device's configuration before enabling and/or before allowing the device to enter into the two-way mode. For example, administrative processes executing on the device and/or kit can be configured to validate that the end user has proper connected peripheral devices necessary for high quality video production. In one example, the device verifies connected peripherals, which can include one or more, all, or any combination of: camera, lights, headset, and a display. In order to support two-way mode, two or more nodes need to be connected to the distributed network. Some smart contracts can be set up in advance to trigger the pairing of the two connected devices, for example, at a specified time, based on identifiers and discovery of the identifiers on the network, etc.

According to various embodiments, the two-way mode enables user having devices or kits to participate in a streaming video interview with a remote party, whilst being recorded via audio and video. In some embodiments, one of the two devices can be established as a lead system, which is configured to accept and execute control of the second device. For example, an interviewer can ship an enclosure and/or complete kit to a interviewee. Once the shipped devices validate proper configuration (i.e., passes validation checks for installed camera, microphone, headset, lights, etc.) and the lead device is on the distributed network, the lead device can request and have control of the second device pass to the lead device. The remote interviewer can then control camera functions (e.g., zoom, aperture, white balance, etc.), light functions (e.g., brightness level, dim operations, etc. (as available), microphone settings (e.g., capture rate, etc.). According to one embodiment, the second device is configured to identify available function on attached components, and pass control of the same to the lead device/kit.

In one example, a recipient can receive a device or complete kit vis mail or bike messenger, and the user can then set up the device or kit. In some settings the user must connect all external peripherals to enable the two-way mode: camera, lights, headset, and a display are connected (and, for example, validated by the device). Where user receives only a device, the user supplies the remaining peripherals to set up the two mode. In further embodiments, the user can be notified by the device of any missing or non-functional peripherals needed. For example, when the user attempts to enter the two-way mode, the device can report back on any issues (including, for example, no other connected devices). As the mode name implies, the two-way mode requires two or more nodes be connected to the network to achieve full functionality. In some embodiments, the functionality that does not need two way communication can be used, until a second system is available. The device and/or kit can includes a state indicator shown in a UI that reflects a reduced functionality state (e.g., “waiting for second system,” etc.), and can provide another indicator when the other systems is connected to the network.

According to other embodiments, the two way mode can facilitate capture of interviews and retentions of the same to broadcast to the network. In other embodiments, the device can archive such interviews to a cloud based storage and broadcast pre-recorded interviews when a time slot is scheduled. According to various embodiments, time-slots for live broadcast are managed via a web interface and scheduling server. The scheduling server can limit time slot allocation based on popularity, frequency of content (e.g., commitment to weekly daily, production, etc.), payments, etc.

According to another embodiment, the device can be configured for an idle mode or default mode when not being used to broadcast or received. For example, the device can be configured to display a wallet address and balance associated with the distributed network. The device is configured to generate new wallet addresses, and hold third-party tokens (tokens on the distributed network represent any fungible tradable good: coins, loyalty points, gold certificates, IOUs, in game items, etc.). The idle mode can also be configured to display recent transactions, and other network based or administrative information.

According to one embodiment, the video production kits can broadcast content to other nodes (e.g., devices or kits) in the network. In various implementations, the schedule of times slots for broadcast is quite unlike conventional television models. For example, conventional video distribution networks (i.e., cable TV) use human operators to “slot” videos into certain scheduled windows for playback on the network.

According one embodiment, the system operates autonomously and schedules broadcast without administration. For example, the system eliminates human editors from schedule operations. Instead, the system uses financial bets placed by users in the network to bolster certain nodes (broadcasters)—who accordingly, get their first choice of timeslot for the next 24 hours.

The system does so through micropayments on the distributed transactional network (e.g., via an Ethereum client). The micropayments can be denominated in a network-wide token which may not have value outside the network. Thus, in some embodiments, only tokens earned within the network can be used to pay for broadcasting airtime.

According to various embodiments, royalty payments for consuming content are built into the network. For example, watching content deducts a cryptocurrency micropayment from the receiving node. Micropayments are then paid to the node which created/published the content to the network—not a human user. These micropayments are paid out to the owner(s) of the node as dividends. Thus, popular content creates a large revenue stream over time.

In some embodiment broadcasting of content costs money. If the content is highly popular, then the content will generate positive tokens, which can be use to buy the choicest timeslots.

According to one embodiment, users are incentivized to bet correctly on which nodes will achieve the most popularity, enriching themselves as they bolster their favorite nodes, and watch the value of their tokens grow. More token “wealth” means the ability to buy prime timeslots for broadcast.

Example execution of scheduling: each month, every hardware node in the network holds an automated auction of a finite quantity of its own equity tokens. The quantity and schedule of issuance is fully standardized for all nodes. However, the prices will vary greatly: nodes producing high royalties (i.e., lots of viewers) will fetch higher-priced equity. The price of a node's equity (or its equity futures) within the network is what determines its ability to buy the timeslots it wants.

Example reader/viewer Experience: Users who are consuming content will be presented with one “channel” which plays the day's clips in order, like a traditional TV station would air its shows. The user can also watch content on a time-shifted basis by filtering videos by geographical proximity, by keyword search, or by looking at the content library of a specific node (i.e., that node's library or archive).

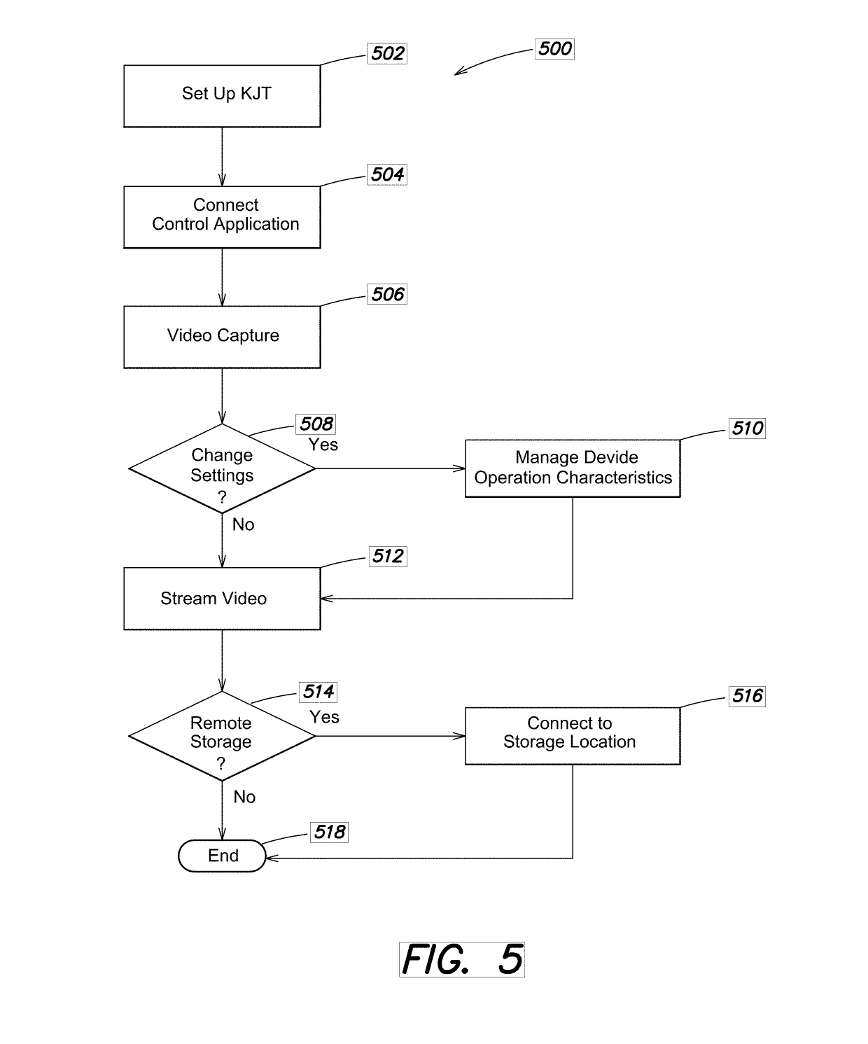

FIG. 5 is an example process flow 500 for video capture, according to one embodiment. Process 500 begins at 502 with the setup and/or activation of a video studio kit. Once the video kit is connected, a user can connect to the kit via an application, browser, etc. at 504. Using, for example, an application on a mobile device, the user can begin video capture at 506. The user can change any of the operating parameter of the kit. For example at 508 YES, the user can change the lighting (e.g., change hue, brightness, on/off, etc.). The user can manage any operating characteristics of the video devices incorporated into the kit at 510. Video can be streamed directly to the user at 512. In some embodiments, the video feed can be stored remotely, for example, in a cloud base storage location. If remote storage is desired and/or configured 514 YES, process 500 continues with connecting to the storage location at 516 and streaming the video feed to storage. In other embodiments, video is broadcast live from the device/kit to content servers (e.g., cloud hosted or dedicated hardware servers) and then mirrored out through a content delivery network (CDN) to other devices/kits.

Once the video capture is concluded process 500 ends at 518. If no remote storage is used 514 NO, process 500 ends at 518 with the conclusion of the video capture. In another embodiment, the device can maintain a local copy of recorded video, for example, to enable re-broadcast.

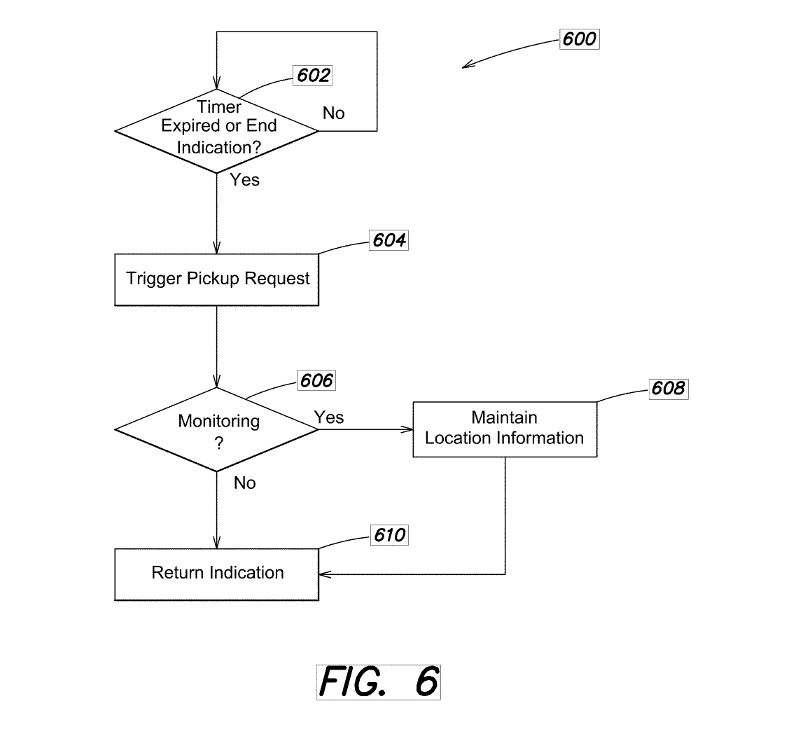

FIG. 6 illustrates a process 600 for automatic return of the video kit and/or system. Typically a video kit is delivered on demand. For example a user schedules a time period and a location for delivery of a video kit. Once the length of time expires or the user concludes their video session, the kit and/or system can be configured to automatically request that the kit and/or system be return. Process 600 begins with testing if a period for the rental has expired or if the user has triggered an end of use indicator at 602. If NO, the process loops to continue testing of a end of time/end of use indication at 602. If YES, process 600 continues with triggering a remote pick-up request at 604. In some examples, triggering a remote pick up includes interfacing with the know UBER application, and requesting a driver or bike pick up at the kit's current location for an automated return. Once requested, location information can be monitored to track the return process. For example, at 606 YES, location monitoring is triggered for the kit and/or the service that was requested for delivery. Location information is maintain at 608 until a return indication is provided at 610. The return indication can include detecting the location information from 608 matches the desired destination.

In other embodiments, automated dispatch and pickup of the video studio kits and/or system can be implement through an on-demand delivery API such as POSTMATES or UBER RUSH. In some implementations, end users can trigger automated dispatch and/or pickup via an application or online user interface. In some examples, video studio kits are made available for 3-hour video session increments. As discussed, when the kit and/or system is sent into the field without a human attendant, the rig can operate autonomously, including automated request of a pickup and return of the equipment. For example, upon completion of the video session, the kit and/or system can request a pick up via UBER RUSH or POSTMATES and be returned to base.

Various embodiments of the video studio kit and/or the video production system are configured to provide on demand high quality video production services. In various embodiments, the kits and systems are configured to provide any one or more or any combination of the following features:
a user's own connected video studio, anywhere
at least a core implementation including a horizontal enclosure with lights on top that are controllable with a remote interface (e.g., from any web browser), which can include an integrated power supply
connectivity anywhere via a communication component (e.g. integrated 3G data SIM with powerful antenna)
front-facing mobile device (e.g., iPhone, ANDROID, GOOGLE device, etc.) to take images, video, sound, etc., enabling better-looking, better-sounding FACETIME, SKYPE, or GOOGLE HANGOUTS—plus additional embodiments include an integrated professional speaker and can also include a boom-mounted background light
mounting architecture for the enclosure can accommodate a digital single lens reflex camera (“dSLR”), camcorder, or action camera to record one or both sides of a conversation
include a rear-facing mobile device (e.g., IPHONE) to provide a control application to manage the manual camera settings locally or remotely—manage lighting settings, video capture settings, audio capture settings, etc.
easy setup and execution is enabled where users remove the kit/rig from a delivered suitcase, press the power button, and the kit's lights spring to life, and video recording can be configured to begin automatically—all that is needed from the user's perspective is a location to place a video call
networking between systems and/or kits: establishes a network of portable video phone booths to create a call with two or more people and control each other's lights for the most beautiful or dramatic effects, and record parts of the conversation for a video podcast, YouTube channel, or for entertainment
integrated batteries to provide at least 5 hours of video production time, and eliminates being ties to extension cords or available power
kits and/or systems can be delivered, for example, by UBER RUSH or POSTMATES and the kit and/or system can automatically request return to an originating location
APIs establish a developer platform—where customer application can integrate and enhance, for example, video production functionality
video control/editing of captured video—including facial recognition to identify subjects and focus areas, and further to identify emotional high points of a video, allowing for automated editing and clip-cutting

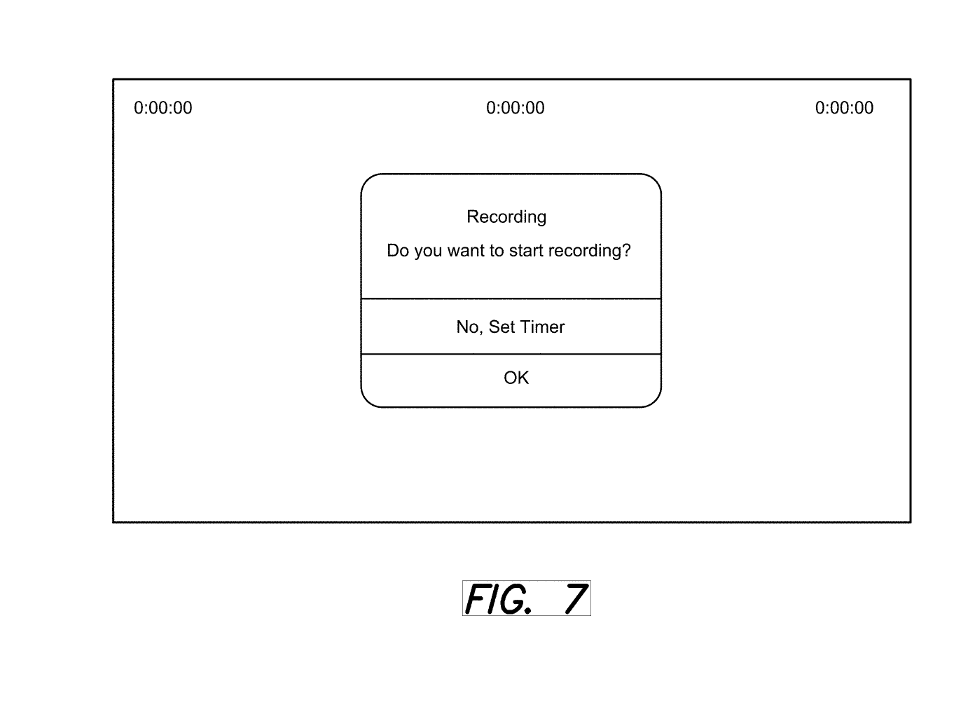

According to one embodiment, the system includes applications and/or user interface displays executable on mobile devices that enable, for example, the mobile device user to control the video product systems and/or kits. Through the applications and/or user interfaces the mobile device user can remotely control video production functions or the user can directly access the mobile devices that come with the video production systems/kits. FIGS. 7-9 show example user interfaces implemented on various mobile devices (e.g., IPHONE). FIG. 7 illustrates a first view generated by an example user interface (UI). The example UI prompts the user for an input on whether to start recording the video display being captured from the video production system. The UI can be configured to track and display information on time remaining for a video production session (e.g., a rental period) as well as record time information. The applications and/or the UI enable shooting of video through video production system/kit. Based on system settings, the video production feed being captured (e.g., video images, sound, etc.) is transmitted to cloud based storage rather than being stored on a mobile device directly. In some embodiments, this is done as high definition (HD) video files are very large and might fill the mobile device and associated storage quickly.

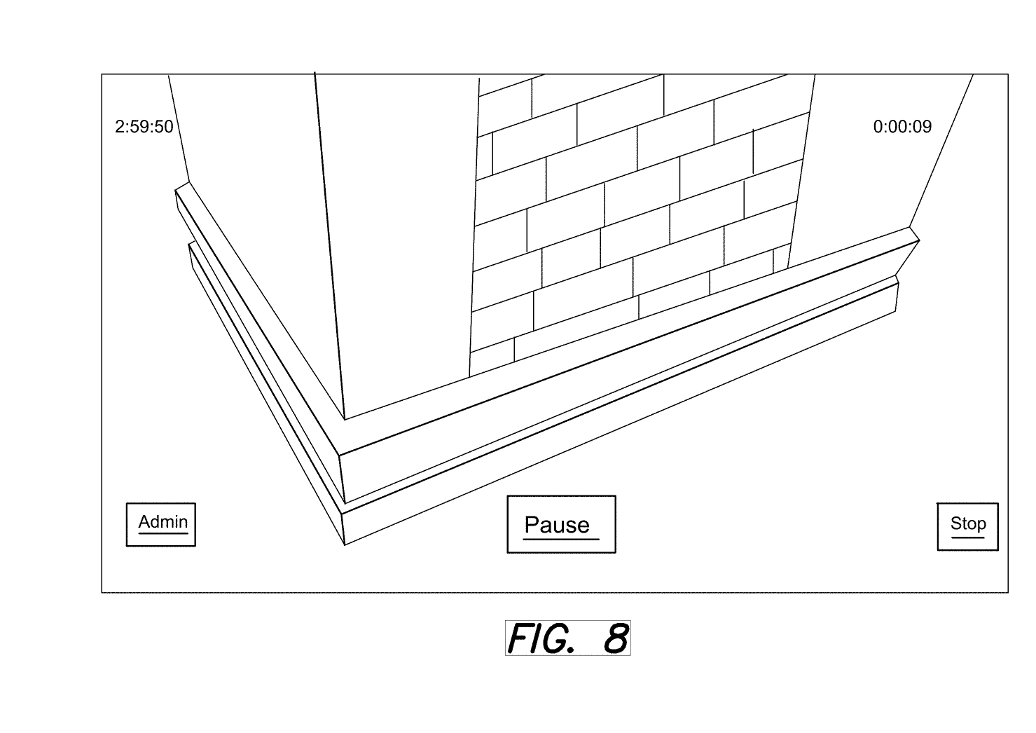

In further embodiments, the application/Uls can be configured to enable the user to also store the video production feed to their user device. In further examples, the user can specify a recording quality to capture on the mobile device memory to reduce the storage requirements for the user's phone. In one example, users can access storage settings by selection of administrative functions in the UI (see e.g., FIG. 8). Selection of “admin” in the UI can take the user to video administration setting, as well as provide access to other administrative functions (e.g., storage location for video feed (e.g., cloud storage location, local copy enable/disable, recording quality setting for local copy if enabled, etc.).

FIG. 7 illustrates a pop up display for a timer feature implemented through the applications and/or user interfaces. In some examples, the timer feature enables the user to begin shooting at a specific point in the future (e.g., specified time), so that the user can send the video product system/kit to an interviewee without a human camera operator. In some examples, the timer features triggers the mobile devices attached to the system/kit to stay locked and respective screens dark. In some implementations, the timer based lock provides both security and battery-saving measures. In an example scenario, the recipient of the video production system/kit would take the system out of the shipping case, and then sit for a recording/interview at the appointed time.

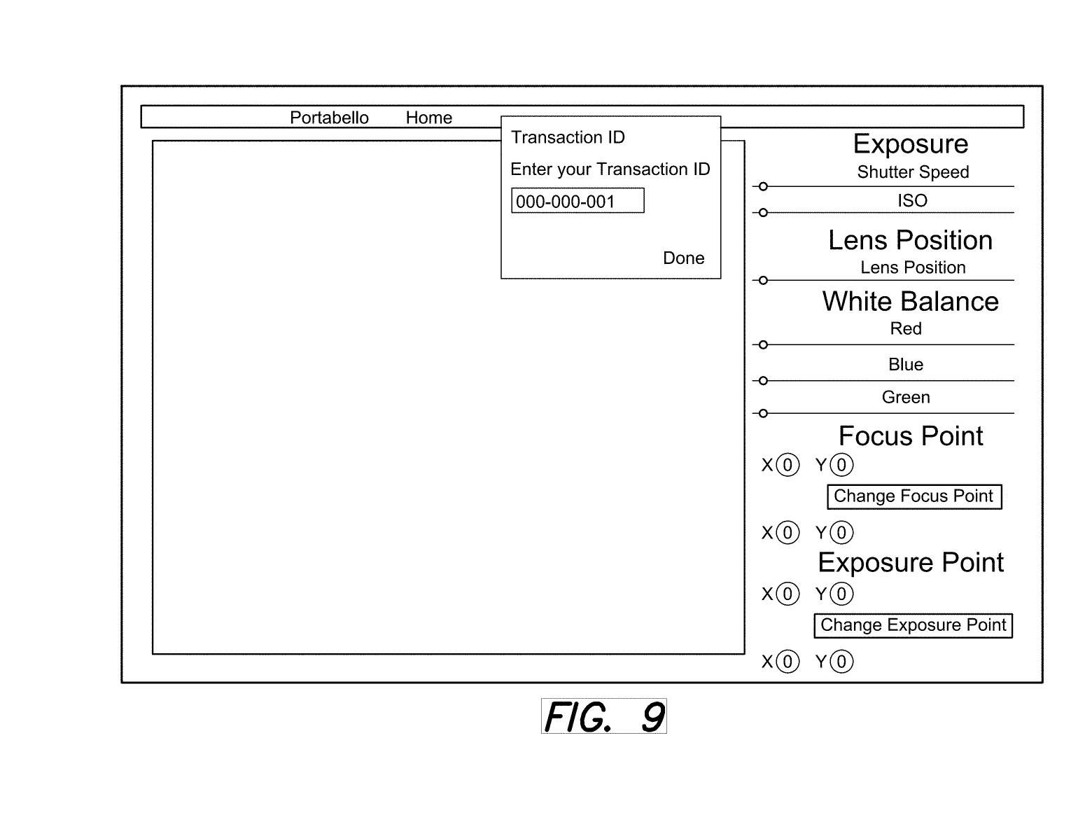

FIG. 9 illustrates another example UI. In one embodiment, the UI can be accessed from a desktop computer or other computer system (e.g., mobile device). As shown in the example, the web view provides the control interface for the mobile camera application. The web view includes a video display (e.g., currently shown as a black box) which renders currently captured video. For example, the remote operator would see the video production feed (e.g., camera images, sound, etc.) in the video display portion of the UI. In some embodiments, the operator uses the toggles on the side of the UI display to adjust manual camera settings like focus point, white balance, exposure, and film speed, among other options.

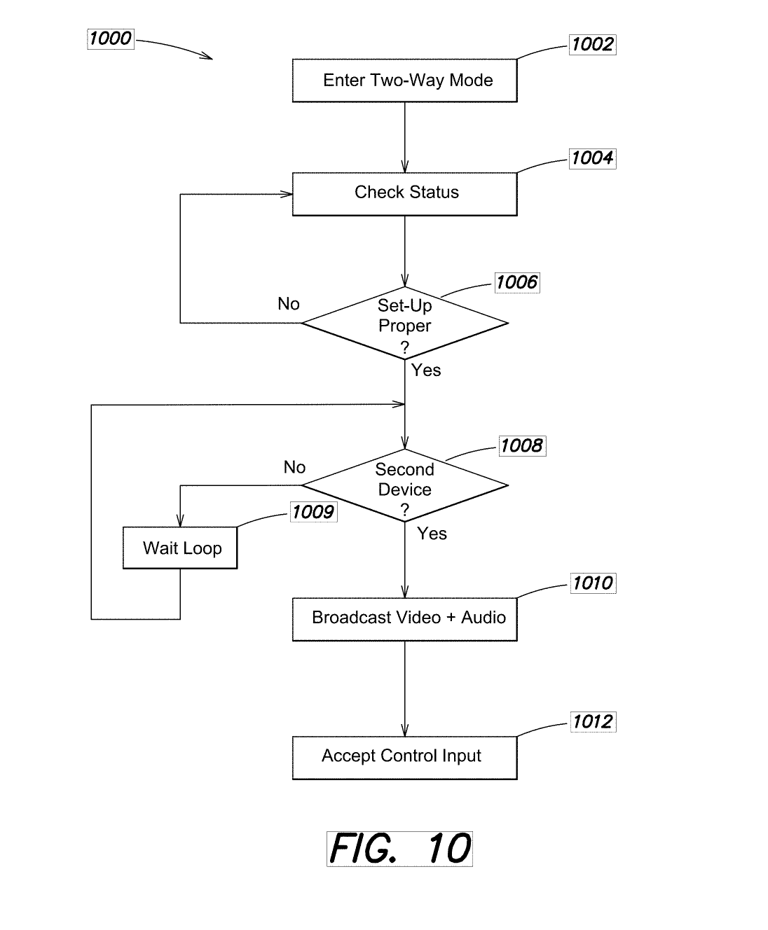

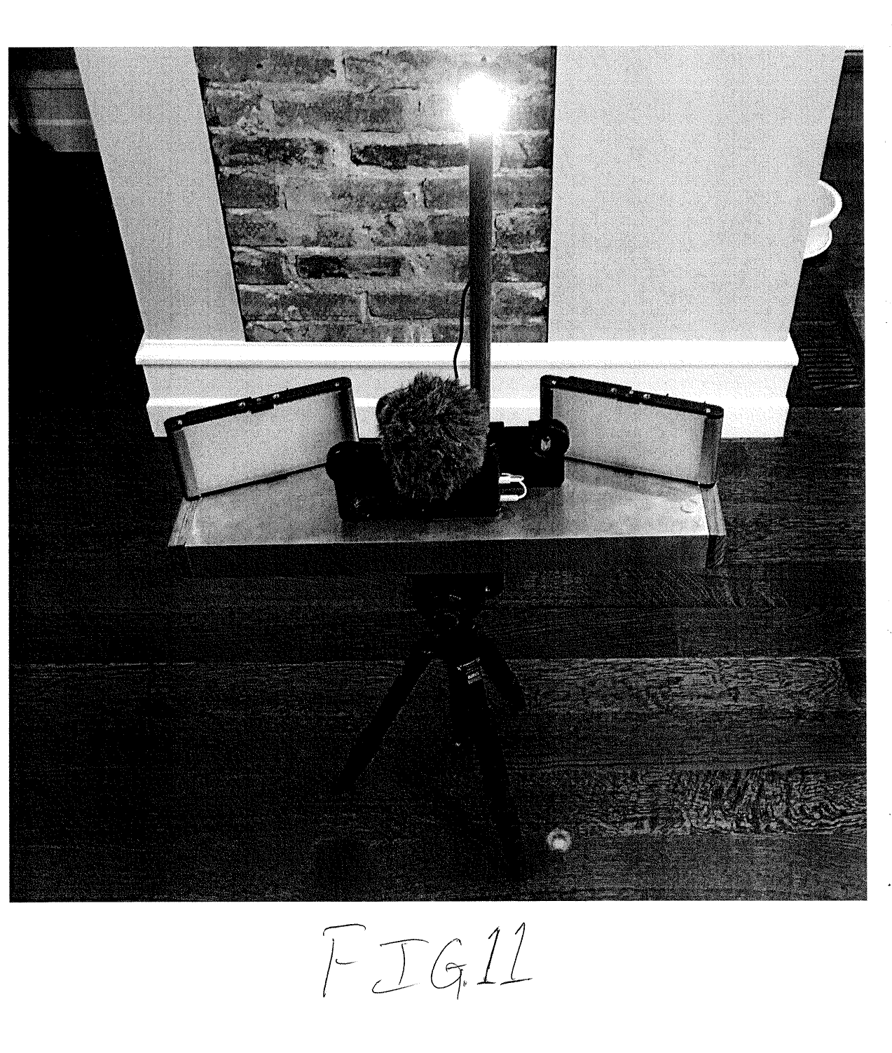

FIG. 10 illustrates an example process flow 1000 for executing a two-way mode session. Process 1000 begins at 1002 with a first device entering the two-way mode at 1002. At 1004, the device validates a current configuration to determine that the device is properly set up for two-way mode. If the device includes all specified peripherals (e.g., camera, lights, headset, microphone, etc.), that are connected and accessible by the device the set-up is proper 1006 YES and the process continues at 1008 with a check for a second device for the two-way session. If the status check determines that the set-up is not proper 1006 NO, the device can provide alerts of the failed conditions. For example, the device can display warning messages—“______ device not connected or functional.” The process can continue to check status at 1004 until the device passes the set-up validation test.

If device is set-up properly, (1006 YES), the process continues with a determination of whether a second device is available to participate in the two-way mode operation at 1008. For example, the device can check transaction records to determine presence of another node on the distributed network associated with the two-way mode session. If no indication that another device is available is detected 1008 NO, the first device can enter a wait loop (1009), re-checking for another device at 1008 until the other device is available or present (1008 YES). Once the other device is available, process 1000 can continue with broadcasting video and audio at 1010. In some embodiments, the broadcast of the first device can be controlled via a second device participating in the two-way mode session. For example, at 1012, the first device can accept control commands from the second device (e.g., zoom, increase lighting intensity, decrease light intensity, change microphone sample rate, change video frame capture rate, etc.). Optionally, the first device can provide control commands to the second device, for example, to improve the video interaction taking place on the two-way sessions. While in two-way mode, both participating devices can be broadcasting to the content servers and the interview (e.g., video and audio content) can be mirrored throughout the network. In other embodiments, the two-way mode session can be captured in local storage on either device, or streamed to a cloud storage location, for example, as a pre-recorded interview broadcast that may be scheduled for a later time.

Various embodiments of the enclosure can include different architectures, different numbers of mounting points and/or positions. In some embodiments, the number of mounting points is limited to a minimal number of devices (e.g., two foreground lights, one background light, two camera mounts, microphone mount (which can be connected to one of the camera mounts rather than to the enclosure) and any cables need to connect the devices.

Various aspects and functions described herein may be implemented as specialized hardware or software components executing in one or more specialized computer systems. According to some embodiments, the devices and/or the devices as integrated into video studio kits are specially programmed to executed the functionality discussed above. For example, the devices can include lightweight and/or small form factor processors that manage a plurality of executable modes, each mode associated with respective video studio functionality. The lightweight and/or small form factor processors can also be managed by lightweight operating system tailored to support the video studio functionality and plurality of operating modes of the device. For example, a LINUX based distribution can operate on an embedded processor and support the multi-mode operation discussed above, as well as the respective video studio functionality.

There are many examples of computer systems that are currently in use that could be specially programmed or specially configured. These examples include, among others, network appliances, personal computers, workstations, mainframes, networked clients, servers, media servers, application servers, database servers, and web servers. Other examples of computer systems may include mobile computing devices (e.g., smart phones, tablet computers, and personal digital assistants) and network equipment (e.g., load balancers, routers, and switches). Examples of particular models of mobile computing devices include iPhones, iPads, and iPod Touches running iOS operating systems available from Apple, Android devices like Samsung Galaxy Series, LG Nexus, and Motorola Droid X, Blackberry devices available from Blackberry Limited, and Windows Phone devices. Further, aspects may be located on a single computer system or may be distributed among a plurality of computer systems connected to one or more communications networks.

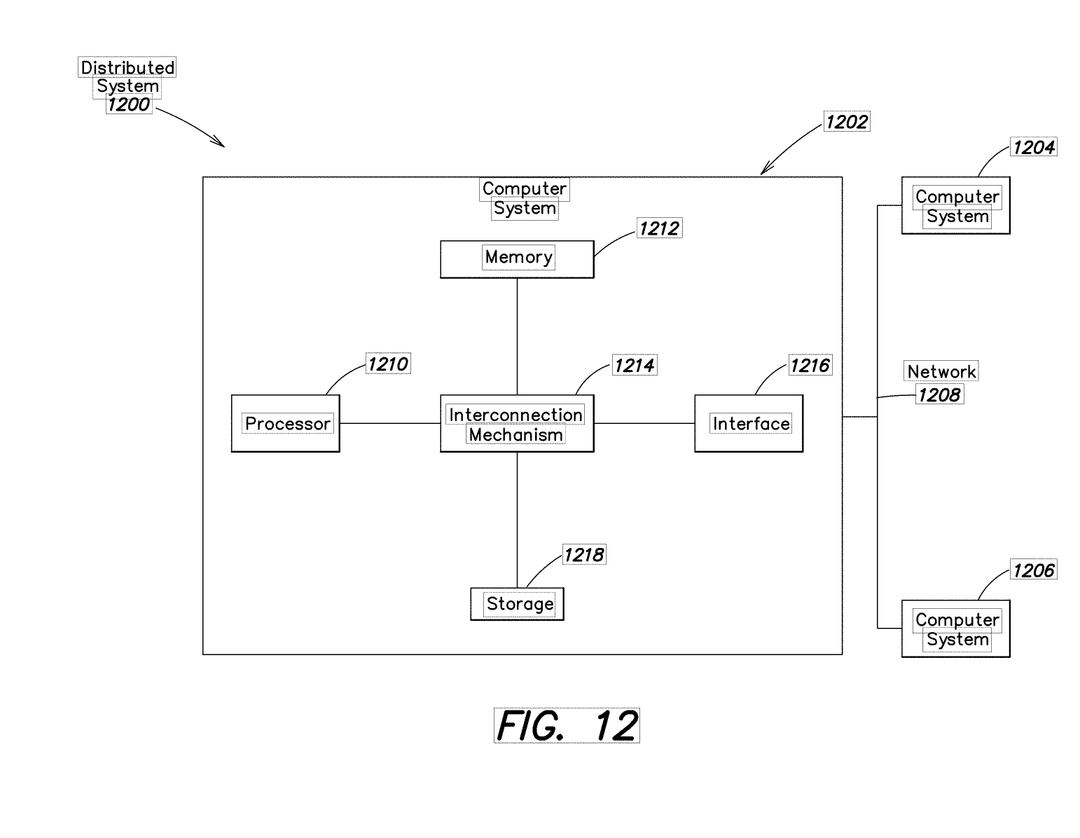

For example, various aspects, functions, and processes may be distributed among one or more computer systems configured to provide a service to one or more client computers, or to perform an overall task as part of a distributed system, such as the distributed computer system 1200 shown in FIG. 12. According to some embodiments, the computer components illustrated and software referenced above provide an operating platform on which distributed blockchain/transactional networks operate. The blockchain network can provide functions associated with smart contracts and transaction execution that enable individual devices or enclosures to request and receive content, and also to be compensated for broadcasting content to the network. In one example, each device/kit can include a blockchain client that provides network functionality and transactional execution functionality (e.g., each device/kit can include an Ethereum client that enables operations on an Ethereum network for blockchain style transactions). Video services installed can include and/or support a SAAS/LAMP stack for providing video services. Additionally, aspects may be performed on a client-server or multi-tier system that includes components distributed among one or more server systems that perform various functions. Consequently, embodiments are not limited to executing on any particular system or group of systems. Further, aspects, functions, and processes may be implemented in software, hardware or firmware, or any combination thereof. Thus, aspects, functions, and processes may be implemented within methods, acts, systems, system elements and components using a variety of hardware and software configurations, and examples are not limited to any particular distributed architecture, network, or communication protocol.

Referring to FIG. 12, there is illustrated a block diagram of a distributed computer system 1200, in which various aspects and functions are practiced. As shown, the distributed computer system 1200 includes one or more computer systems that exchange information. More specifically, the distributed computer system 1200 includes computer systems 1202, 1204, and 1206. As shown, the computer systems 1202, 1204, and 1206 are interconnected by, and may exchange data through, a communication network 1208. The network 1208 may include any communication network through which computer systems may exchange data. To exchange data using the network 1208, the computer systems 1202, 1204, and 1206 and the network 1208 may use various methods, protocols and standards, including, among others, Fiber Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, and Web Services. To ensure data transfer is secure, the computer systems 1202, 1204, and 1206 may transmit data via the network 1208 using a variety of security measures including, for example, SSL or VPN technologies. While the distributed computer system 1200 illustrates three networked computer systems, the distributed computer system 1200 is not so limited and may include any number of computer systems and computing devices, networked using any medium and communication protocol.

As illustrated in FIG. 12, the computer system 1202 includes a processor 1210, a memory 1212, an interconnection element 1214, an interface 1216 and data storage element 1218. To implement at least some of the aspects, functions, and processes disclosed herein, the processor 1210 performs a series of instructions that result in manipulated data. The processor 1210 may be any type of processor, multiprocessor or controller. Example processors may include a commercially available processor such as an Intel Xeon, Itanium, Core, Celeron, or Pentium processor; an AMD Opteron processor; an Apple A4 or A5 processor; a Sun UltraSPARC processor; an IBM Power5+ processor; an IBM mainframe chip; or a quantum computer. The processor 1210 is connected to other system components, including one or more memory devices 1212, by the interconnection element 1214.

The memory 1212 stores programs (e.g., sequences of instructions coded to be executable by the processor 1210) and data during operation of the computer system 1202. Thus, the memory 1212 may be a relatively high performance, volatile, random access memory such as a dynamic random access memory (“DRAM”) or static memory (“SRAM”). However, the memory 1212 may include any device for storing data, such as a disk drive or other nonvolatile storage device. Various examples may organize the memory 1212 into particularized and, in some cases, unique structures to perform the functions disclosed herein. These data structures may be sized and organized to store values for particular data and types of data.

Components of the computer system 1202 are coupled by an interconnection element such as the interconnection element 1214. The interconnection element 1214 may include any communication coupling between system components such as one or more physical busses in conformance with specialized or standard computing bus technologies such as IDE, SCSI, PCI and InfiniBand. The interconnection element 1214 enables communications, including instructions and data, to be exchanged between system components of the computer system 1202.

The computer system 1202 also includes one or more interface devices 1216 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 1202 to exchange information and to communicate with external entities, such as users and other systems.

The data storage element 1218 includes a computer readable and writeable nonvolatile, or non-transitory, data storage medium in which instructions are stored that define a program or other object that is executed by the processor 1210. The data storage element 1218 also may include information that is recorded, on or in, the medium, and that is processed by the processor 1210 during execution of the program. More specifically, the information may be stored in one or more data structures specifically configured to conserve storage space or increase data exchange performance. The instructions may be persistently stored as encoded signals, and the instructions may cause the processor 1210 to perform any of the functions described herein. The medium may, for example, be optical disk, magnetic disk or flash memory, among others. In operation, the processor 1210 or some other controller causes data to be read from the nonvolatile recording medium into another memory, such as the memory 1212, that allows for faster access to the information by the processor 1210 than does the storage medium included in the data storage element 1218. The memory may be located in the data storage element 1218 or in the memory 1212, however, the processor 1210 manipulates the data within the memory, and then copies the data to the storage medium associated with the data storage element 1218 after processing is completed. A variety of components may manage data movement between the storage medium and other memory elements and examples are not limited to particular data management components. Further, examples are not limited to a particular memory system or data storage system.

Although the computer system 1202 is shown by way of example as one type of computer system upon which various aspects and functions may be practiced, aspects and functions are not limited to being implemented on the computer system 1202 as shown in FIG. 12. Various aspects and functions may be practiced on one or more computers having a different architectures or components than that shown in FIG. 12. For instance, the computer system 1202 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 1202 may be a computer system including an operating system that manages at least a portion of the hardware elements included in the computer system 1202. In some examples, a processor or controller, such as the processor 1210, executes an operating system. Examples of a particular operating system that may be executed include a Windows-based operating system, such as, Windows NT, Windows 2000 (Windows ME), Windows XP, Windows Vista or Windows 7, 8, or 10 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 1210 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Based on the foregoing disclosure, it should be apparent to one of ordinary skill in the art that the embodiments disclosed herein are not limited to a particular computer system platform, processor, operating system, network, or communication protocol. Also, it should be apparent that the embodiments disclosed herein are not limited to a specific architecture or programming language.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Use of “at least one of:” and a list of elements (e.g., A, B, and C) is intended to cover one option from A, B, C (e.g., A), two options from A, B, C (e.g., A and B), three options (e.g., A, B, C), and multiples of each option or option combinations (e.g., 2As or 2 B, or 2As with 2Bs, etc.).

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A video production kit, the kit comprising:
an enclosure, wherein the enclosure further includes:
a processing component having at least one processor operatively connected to a memory;
a communication component;
a battery;
a first port for receiving a physical connector to a first light;
a second port for receiving a physical connector to a first camera;
a first mount within the enclosure constructed to mate with the first camera;
a second mount within the enclosure constructed to mate with a tripod; and
wherein the processing component is configured to control the first camera and the first light responsive to control commands received via the communication component.

2. The kit of claim 1, further comprising a first light connectable to the enclosure through a physical connector or through the communication component and a first camera connectable to the enclosure through a physical connector or through the communication component.

3. The kit of claim 1, further comprising at least a second light connectable to the enclosure through a physical connector or through the communication component, wherein the first and the at least the second light are positioned to illuminate a foreground and background within captured video.

4. The kit of claim 1, further comprising a discovery component, executed by the at least one processor, configured to identify and install a plurality of video production devices, wherein the plurality of video production devices include at least one of: a first camera, a first light, a first microphone, and a first headset which can include the first microphone.

5. The kit of claim 1, wherein the at least one processor is further configured to manage transitions between a plurality of operating modes responsive to requests in a user interface.

6. The kit of claim 5, wherein the plurality of operating modes includes at least one of:
broadcast mode, a receive mode, and a two-way mode.

7. The kit of claim 5, wherein the at least one processor is further configured to:
execute a transition to a two-way mode responsive to input in a user interface;
test connected video production devices to determine a proper state for functionality within the two-way mode; and
permit full functionality in the two-way mode responsive to a successful test.

8. The kit of claim 7, wherein the at least one processor is configured to:
deny a transition to two-way mode responsive to a failed test; and
enter a reduced functionality two-way mode or prevent transition to the two-way mode; and
communicate to the user interface information on a failure condition.

9. The kit of claim 7, wherein the at least one processor is further configured to establish a broadcast to a second video production kit and received a broadcast from the second video production kit when in the two-way mode.

10. The kit of claim 9, wherein the at least one processor is further configured to accept and execute control commands on the plurality of video production devices from the second video production kit when in the two-way mode.

11. The kit of claim 5, wherein the at least one processor is configured to:
execute a transition to a broadcast mode responsive to input in a user interface;
capture video from a first camera and audio from a first microphone;
communicate a data stream including the video and the audio to a content server; and
receive and authorization signal from the content server to broadcast.

12. The kit of claim 5, wherein the at least one processor is configured to:
execute a transition to a receive mode responsive to input in a user interface;
receive a data stream including video and audio generated at another video production kit;
display in a user interface the video and audio; and
limit functionality in the receive mode to display of the data stream and exiting the received mode.

13. A video production system, the system comprising:
at least one processor operatively connected to a memory constructed and arranged within a portable enclosure;
a discovery component, executed by the at least one processor, configured to identify and install a plurality of video production devices, wherein the plurality of video production devices include at least a first camera, a first light, a first microphone, and a first headset which can include the first microphone, wherein the plurality of video production devices are connectable to the portable enclosure via a physical connector or wirelessly;
a video capture component, executed by the at least one processor, configured to control operating parameters of at least the first camera, the first light, and the first microphone;
a communication component configured to accept remote commands from at least one user, and communicate the remote commands to the video capture component to control the operating parameters of the first camera, the first light, and the first microphone; and
the portable enclosure housing the at least one processor and at least one battery, wherein the portable enclosure is constructed and arranged with a plurality of communication ports for at least respective ones of the plurality of video production devices, and a first mount for the first camera and a second mount for a tripod.

14. The system of claim 13, wherein the at least one processor is further configured to manage transitions between a plurality of operating modes responsive to requests in a user interface.

15. The system of claim 14, wherein the plurality of operating modes includes at least one of:
broadcast mode, a receive mode, and a two-way mode.

16. The system of claim 14, wherein the at least one processor is further configured to:
execute a transition to a two-way mode responsive to input in a user interface;
test connected video production devices to determine a proper state for functionality within the two-way mode; and
permit full functionality in the two-way mode responsive to a successful test.

17. The system of claim 16, wherein the at least one processor is configured to:
deny a transition to two-way mode responsive to a failed test;
enter a reduced functionality two-way mode or prevent transition to the two-way mode; and
communicate to the user interface information on a failure condition.

18. The system of claim 16, wherein the at least one processor is further configured to establish a broadcast to a second video production system and received a broadcast from the second video production system when in the two-way mode.

19. The system of claim 18, wherein the at least one processor is further configured to accept and execute control commands on the plurality of video production devices from the second video production system when in the two-way mode.

20. The system of claim 14, wherein the at least one processor is configured to:
execute a transition to a broadcast mode responsive to input in a user interface;
capture video from a first camera and audio from a first microphone;
communicate a data stream including the video and the audio to a content server; and
receive and authorization signal from the content server to broadcast.

21. The system of claim 14, wherein the at least one processor is configured to:
execute a transition to a receive mode responsive to input in a user interface;
receive a data stream including video and audio generated at another video production system;
display in a user interface the video and audio; and
limit functionality in the receive mode to display of the data stream and exiting the received mode.

22. A computer implemented method for video production, the method comprising:
discovering, by at least one processor, a plurality of video production devices for use in a video production kit;
controlling, by at least one processor, the plurality of video production devices via commands input into a remote interface;
managing, by at least one processor, transitions between a plurality of operating modes for the video production kit;
triggering video capture by the video production system; and
manipulating operational characteristics of the plurality of devices during video capture via input into the remote interface.

23. The method of claim 22, wherein the plurality of operating modes includes at least one of: broadcast mode, a receive mode, and a two-way mode.

24. The method of claim 22, further comprising:
executing, by the at least one processor, a transition to a two-way mode responsive to input in a user interface;
testing, by the at least one processor, connected video production devices to determine a proper state for functionality within the two-way mode; and
permitting, by the at least one processor, full functionality in the two-way mode responsive to a successful test.

25. The method of claim 22, further comprising establishing, by the at least one processor, a broadcast to a second video production system and receiving, by the at least one processor, a broadcast from the second video production system when in the two-way mode.

26. The method of claim 25, further comprising accepting, by the at least one processor, and executing, by the at least one processor, control commands on the plurality of video production devices from the second video production system when in the two-way mode.
